(19) United States
(12) Patent Application Publication
(10) Pub. No.: US 2020/0287747 A9
(43) Pub. Date: Sep. 10, 2020

(54) SYSTEMS AND METHODS FOR USING A COMMON CONTROL PLANE TO CONTROL A PLURALITY OF ACCESS NETWORKS

(71) Applicant: CABLE TELEVISION LABORATORIES, INC., Louisville, CO (US)

(72) Inventors: Jennifer Andreoli-Fang, Boulder, CO (US); Bernard McKibben, Golden, CO (US)

(21) Appl. No.: 16/698,765

(22) Filed: Nov. 27, 2019

Related U.S. Application Data
(63) Continuation-in-part of application No. 16/367,997, filed on Mar. 28, 2019.
(60) Provisional application No. 62/928,528, filed on Oct. 31, 2019.
(60) Provisional application No. 62/772,839, filed on Nov. 29, 2018.
(60) Provisional application No. 62/772,542, filed on Nov. 28, 2018.
(60) Provisional application No. 62/722,380, filed on Aug. 24, 2018.
(60) Provisional application No. 62/678,920, filed on May 31, 2018.
(60) Provisional application No. 62/659,200, filed on Apr. 18, 2018.
(60) Provisional application No. 62/655,213, filed on Apr. 9, 2018.
(60) Provisional application No. 62/649,284, filed on Mar. 28, 2018.
(60) Provisional application No. 62/746,735, filed on Oct. 17, 2018.

(51) Int. Cl. H04L 12/46; H04L 12/28; H04L 12/24

(52) U.S. Cl. CPC H04L 12/4604; H04L 41/5077; H04L 12/2865; H04L 12/2861

(57) ABSTRACT

A method for using a common control plane to control a plurality of access networks includes (1) supporting a first communication link of a first access network using a control plane of the first access network, and (2) supporting a second communication link of a second access network using the control plane of the first access network. A communication system includes the first access network and the second access network.

### RELATED APPLICATIONS

This application is a continuation-in-part of U.S. patent application Ser. No. 16/376,904, filed on Mar. 14, 2019, which claims benefit of priority to (a) U.S. Provisional Patent Application Ser. No. 62/649,284, filed Mar. 28, 2018, (b) U.S. Provisional Patent Application Ser. No. 62/655,213, filed Apr. 9, 2018, (c) U.S. Provisional Patent Application Ser. No. 62/659,200, filed Apr. 18, 2018, (d) U.S. Provisional Patent Application Ser. No. 62/678,920, filed May 31, 2018, and (e) U.S. Provisional Patent Application Ser. No. 62/722,380, filed Aug. 24, 2018. This application additionally claims benefit of priority to (a) U.S. Provisional Patent Application Ser. No. 62/772,542, filed Nov. 28, 2018, (b) U.S. Provisional Patent Application Ser. No. 62/772,839, filed Nov. 29, 2018, (c) U.S. Provisional Patent Application Ser. No. 62/928,528, filed Oct. 31, 2019, and (d) U.S. Provisional Patent Application Ser. No. 62/746,735, filed on Oct. 17, 2018. Each of the aforementioned applications is incorporated herein by reference.

### BACKGROUND

Wireless communication networks and wireline communication networks are ubiquitous in modern society. These networks typically operate according to standard protocols, such as to facilitate interoperability of network devices from different vendors. However, wireless communication networks typically use different protocols than wireline communication networks. Examples of wireless communication network protocols include long term evolution (LTE) protocols and fifth generation (5G) new radio (NR) protocols. Examples of wireline communication protocols include data over cable service interface specification (DOCSIS) protocols, digital subscriber line (DSL) protocols, ethernet passive optical network (EPON) protocols, gigabit passive optical network (GPON) protocols, and radio frequency over glass (RFOG) protocols.

A control portion of a communication network is commonly referred to as the core communication network. A core communication network is configured to handle, for example, user equipment (UE) device authentication, data management, accounting and billing, and/or data session instantiation and management.

### BRIEF DESCRIPTION OF THE DRAWINGS

FIG. 1 is a block diagram illustrating a converged core communication network supporting wireline and wireless communication links, according to an embodiment.

FIG. 2 is a block diagram illustrating logical elements of one embodiment of the converged core communication network of FIG. 1.

FIG. 3 is a block diagram illustrating a wireline access network, according to an embodiment.

FIG. 4 is a block diagram illustrating an application of the converged core communication network of FIG. 2 where a wireline access network provides backhaul for a wireless base station, according to an embodiment.

FIG. 5 is a block diagram illustrating an application of the converged core communication network of FIG. 2 where a wireline access network provides (1) backhaul for a small cell wireless base station, (2) fixed broadband Internet service, and (3) optional fixed voice service, according to an embodiment.

FIG. 6 is a block diagram illustrating a converged core communication network capable of controlling a UE device served by a wireline access network, according to an embodiment.

FIG. 7 is a block diagram illustrating a converged core communication network capable of controlling an access device as if the access device were a UE device, according to an embodiment.

FIG. 7A is a block diagram of an alternate embodiment of the FIG. 7 converged core communication network.

FIG. 8 is a block diagram illustrating a converged core communication network capable of controlling an access device using the same protocols as the converged core communication network, according to an embodiment.

FIG. 9 is a block diagram illustrating a method for supporting communication links, according to an embodiment.

FIG. 10 is a block diagram of a communication system including a plurality of access networks at least partially controlled by a common control plane, according to an embodiment.

FIG. 11 is a block diagram of an embodiment of the FIG. 10 communication system including two access networks.

FIG. 12 is a block diagram of an embodiment of the FIG. 11 communication system where a first access network includes a wireless base station.

FIG. 13 is a block diagram of an embodiment of the FIG. 12 communication system including a hybrid access device.

FIG. 14 is a block diagram of an embodiment of the FIG. 11 communication system including an UE device supported by a second access network, where the UE device is configured to communicate with a control plane of a first access network.

FIG. 15 is a block diagram of an embodiment of the FIG. 14 communication system where a first access network includes a wireless base station.

FIG. 16 is a block diagram of an embodiment of the FIG. 15 communication system including a hybrid UE device.

FIG. 17 is a block diagram of an embodiment of the FIG. 14 communication system where (1) a first access network is embodied by a first access network of FIG. 15, and (2) a second access network is embodied by a second access network of FIG. 13.

FIG. 18 is a block diagram of an alternate embodiment of the FIG. 17 communication system where a UE device is replaced with a UE device that does not support a control plane of the first access network.

FIG. 19 is a block diagram of an alternate embodiment of the FIG. 11 communication system including a legacy access device.

### DETAILED DESCRIPTION OF THE EMBODIMENTS

While a wireless communication network and a wireline communication network may share some common infrastructure, the wireless core communication network and the wireline core communication network are conventionally separate and isolated entities. Additionally, wireless and wireline communication networks conventionally use (a) different credentials to authenticate and authorize devices, (b) different data management techniques, (c) different accounting and billing systems, and (d) different policies to instantiate and manage data sessions. The need to support these respective functions for each communication network results in significant complexity and cost.

Disclosed herein are core communication networks and associated methods which at least partially overcome one or more of the problems discussed above. The new core communication networks are configured to at least partially control both a wireless communication network and a wireline communication network, and the new core communication networks are therefore referred to as “converged” core communication networks. The converged core communication networks may advantageously enable at least partial sharing of one or more core communication network functions, thereby promoting economy, simplicity, and tight integration of wireless and wireline communication networks. For example, some embodiments are configured to (a) authenticate, authorize, and/or register both wireless devices and wireline devices and their respective subscriptions, (b) instantiate network slices on either a wireless device or a wireline device, (c) create and manage wireless and wireline data sessions with matching Quality of Service (QoS) traffic management policy, based on a common set of policies for both a wireless and wireline communication network, and/or (d) expose structured user data, irrespective of whether a user's device is connected to the wireless or wireline communication network, in a unified and controlled manner. Additionally, some embodiments of the converged core communication networks are at least partially backward compatible with legacy communication networks, thereby helping minimize required change to existing infrastructure.

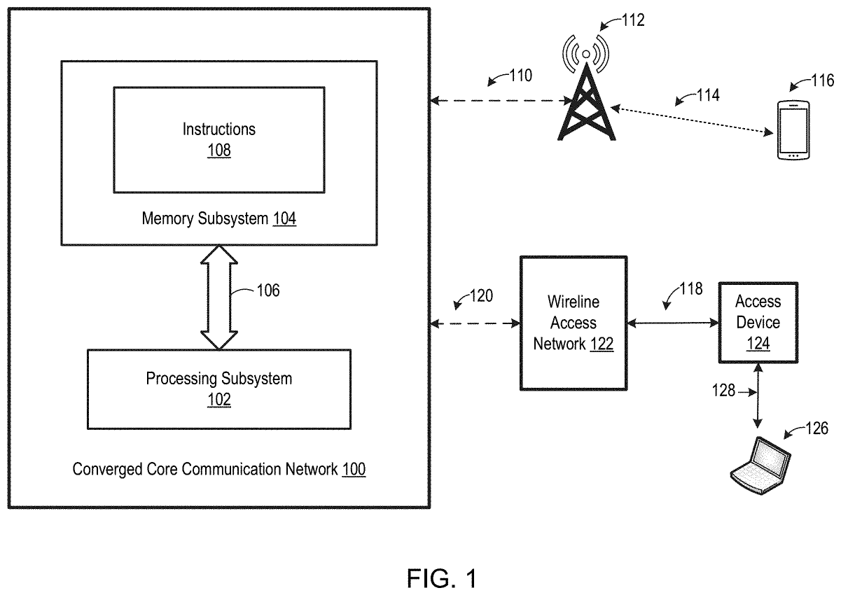

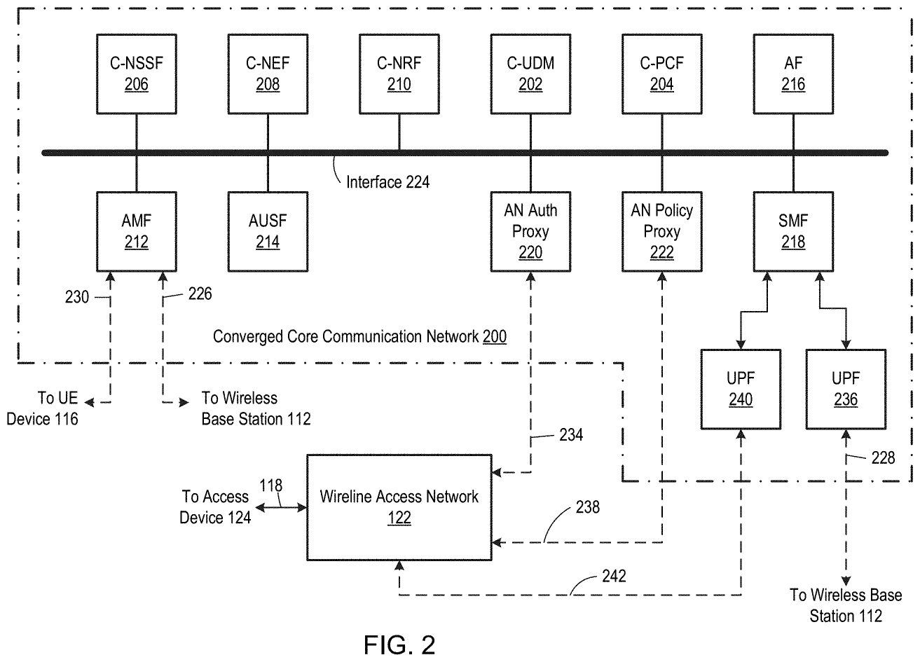

FIG. 1 is a block diagram illustrating a converged core communication network 100 supporting wireless and wireline communication links. Converged core communication network 100 is one embodiment of the new converged core communication networks developed by Applicant, and converged core communication network 100 includes a processing subsystem 102 and a memory subsystem 104. Processing subsystem 102 is communicatively coupled 106 to memory subsystem 104, and processing subsystem 102 is configured to execute instructions 108 stored in memory subsystem 104 to perform the functions of converged core communication network 100, e.g. to provide the network functions depicted in FIG. 2 (discussed below). Although each of processing subsystem 102 and memory subsystem 104 is symbolically shown as a single element, processing subsystem 102 and memory subsystem 104 may include multiple elements. For example, processing subsystem 102 may include multiple processors, and memory subsystem 104 may include multiple memory modules. Additionally, constituent components of each of processing subsystem 102 and memory subsystem 104 need not be disposed at single location; instead, the constituent components may be disposed at multiple locations, e.g. in multiple data centers in different geographic locations. Furthermore, processing subsystem 102 and memory subsystem 104 could be replaced with alternative components performing similar functionality, such as analog and/or digital electronic circuitry, without departing from the scope hereof.

Converged core communication network 100 is configured to support both wireless communication links and wireline communication links. For example, FIG. 1 illustrates converged core communication network 100 being coupled to a wireless base station 112 via a logical link 110, to support a wireless communication link 114 with a UE device 116. Logical link 110 may include a plurality of logical links, such as a 5G NR NG2 logical link and a NG3 logical link. Wireless base station 112 includes, for example, a LTE base station (e.g., an eNB device), a 5G NR base station (e.g., a gNB device), a sixth Generation (6G) wireless communication base station, a Wi-Fi base station (e.g., including unscheduled, partially scheduled, and unscheduled systems), or variations and/or extensions thereof.

Converged core communication network 100 also supports a wireline communication link 118 via a logical link 120 with a wireline access network 122. Logical link 120 may include a plurality of logical links, such as discussed below with respect to FIG. 2. Wireline access network 122 includes, for example, a cable modem termination system (CMTS), a digital subscriber line access multiplexer (DSLAM), or an optical line terminal (OLT). However, wireline access network 122 is not limited to these configurations; instead, wireline access network 122 could have any configuration as long as it is compatible with converged core communication network 100. Wireline communication link 118 communicatively couples an access device 124 to wireline access network 122, and wireline communication link 118 includes, for example, an optical cable or an electrical cable such as a coaxial cable or a twisted pair cable. Additionally, in some embodiments, wireline communication link 118 is hybrid of two or more communication media, such as a hybrid optical cable and coaxial cable (HFC) wireline communication link or a hybrid optical cable and twisted pair cable wireline communication link. Access device 124 is, for example, a cable modem (e.g. operating according to a DOCSIS protocol), a DSL modem, or an optical network unit (ONU) (e.g., operating according to an EPON protocol, a RFOG protocol, or a GPON protocol), or any other device capable of terminating wireline communication link 118. Access device 124 may also be incorporated into another device, such as a premises gateway which provides networking functionality (wireless and/or wired) in addition to wireline communication network access. A UE device 126 is communicatively coupled to access device 124 via a communication link 128, where communication link 128 is a wireless (e.g., Wi-Fi, LTE, 5G NR, or 6G) and/or wireline (e.g., electrical or optical cable) communication link. In some alternate embodiments, access device 124 is itself a UE device capable of connecting to wireline communication link 118.

Converged core communication network 100 provides UE devices 116 and 126 with access to one or more network services, e.g., the Internet, video services, audio services, voice over Internet Protocol (VOIP) services, gaming services, and/or conferencing services. Examples of each of UE device 116 and 126 include, but are not limited to, a computer, a set-top device, a data storage device, an Internet of Things (IoT) device, an entertainment device, a wireless access point (including, for example, eNBs, gNBs, and Wi-Fi APS acting as UEs), a computer networking device, a mobile telephone, a smartwatch, a wearable device with wireless capability, and a medical device.

Although converged core communication network 100 is depicted for illustrative simplicity as supporting only a single wireless communication link 114 and a single wireline communication link 118, converged core communication network 100 could be configured to support a plurality of wireless and/or or wireline communication links without departing from the scope hereof. For example, some embodiments of converged core communication network 100 are capable of supporting hundreds, thousands, tens of thousands, or even more wireless and/or wireline communication links. Similarly, while only two UE devices 116 and 126 are depicted in FIG. 1 for illustrative clarity, converged core communication network 100 could support additional UE devices without departing from the scope hereof. Furthermore, although FIG. 1 illustrates wireless communication link 114 and wireline communication link 118 as being separate entities, in some embodiments, wireless communication link 114 and wireline communication link 118 are part of a common communication path. Moreover, wireless communication link 114 and wireline communication link 118 could support a common UE device, such as to provide a high-bandwidth communication to the UE device.

FIG. 2 is a block diagram illustrating logical elements, e.g. network functions, of a converged core communication network 200, which is one embodiment of converged core communication network 100. In particular embodiments, processing subsystem 102 executes instructions 108 to provide the network functions illustrated in FIG. 2. In the illustrated embodiment, converged core communication network 200 provides at least the following network functions: (1) a converged unified data management (C-UDM) 202, (2) a converged policy control function (C-PCF) 204, (3) a converged network slice function (C-NSSF) 206, (4) a converged network exposure function (C-NEF) 208, (5) a converged network repository function (C-NRF) 210, (6) an access management mobility function (AMF) 212, (7) an authentication server function (AUSF) 214, (8) an application function (AF) 216, (9) a session management function (SMF) 218, (10) an access network (AN) authentication proxy 220, and (11) an policy proxy 222. These network functions are logically linked via a common interface 224. In some embodiments, common interface 224 is configured according to a representational state transfer (REST) application programming interface (API), although common interface 224 could take other forms without departing from the scope hereof.

Converged core communication network 200 could provide additional network functions and/or omit some of the network functions depicted in FIG. 2, without departing from the scope hereof. Additionally, in some embodiments, common interface 224 is communicatively coupled to additional communication networks (not shown) outside of converged core communication network 200, such as one or more of a Wi-Fi network, a fixed wireless network, a legacy wireline communication network, and a satellite network.

In particular embodiments, converged core communication network 200 directly supports wireless communication links, for example, using 5G NR protocols, 6G protocols, or extension and/or variations thereof. In some embodiments, wireless communication link 114 is directly supported by converged core communication network 200 via logical links 226 and 228 to wireless base station 112, and a logical link 230 to UE device 116, discussed below. Additionally, converged core communication network 200 supports wireline communication links, e.g. wireline communication link 118, via a wireline access network 122. In contrast to conventional approaches, wireline access network 122 shares several of the network functions of converged core communication network 200, as discussed below. Accordingly, converged core communication network 200 supports both wireless and wired communication links while helping minimize changes required to legacy wireline access networks.

C-UDM 202 holds service profiles for both wireless and wireline devices and users, e.g. for both UE device 116 using wireless communication link 114 and access device 124 using wireline communication link 118. The service profiles include, for example, identities and properties of authorized devices and/or users, as well as listings of network services and/or network service levels associated with the devices and/or users. For example, C-UDM 202 may hold identities of UE device 116 and access device 124, as well as respective network services that each device 116 and 126 is permitted to access. In some embodiments, AUSF 214 uses authentication information from C-UDM 202 to authenticate both wireless and wireline network access, e.g. AUSF 214 authenticates both UE device 116 and access device 124, such that wireless and wireline authentication is completely converged into converged core communication network 200.

In some other embodiments, AUSF 214 is configured to obtain authentication information from C-UDM 202 to authenticate wireless network access, but wireline access network 122, instead of AUSF 214, authenticates wireline access network, to promote backward compatibility with legacy wireline access networks. In these embodiments, wireline access network 122 obtains authentication information from C-UDM 202 to authenticate wireline access devices, such as access device 124. Wireline access network 122 is optionally configured to post its authentication of an access device, e.g. authentication of access device 124, to C-UDM 202, so that converged core communication network 200 is apprised of both wireless and wireline authentication. In these embodiments, C-UDM 202 is optionally configured to link wireless authentication information and wireline authentication information of a given user with a common identification element for the user. For example, in some embodiments, C-UDM 202 is configured to link a (a) mobile network subscription ID (IMSI) and an authentication protocol (AKA) associated with a wireless UE device of a given user, and (b) a security certificate associated with a wireline access device of the user, with a common identification element for the user. Examples of the security certificate associated with the wireline access device of the user include, but are not limited to, a security certificate for a DOCSIS protocol device, a security certificate for a DSL protocol device, a security certificate for a EPON protocol device, and a security certificate for a GPON protocol device. Furthermore, in some embodiments, C-UDM 202 is configured to link additional authentication information associated with the user, e.g. user Wi-Fi authentication information, with the common identification element for the user. An example of the Wi-Fi authentication information includes, but is not limited to, a security certificate for a Wi-Fi device.

Linking of a given user's various authentication information with a common identification element promotes seamless authentication while supporting legacy wireline access network authentication. For example, C-UDM 202 may provide a user's IMSI and AKA to AUSF 214, to authenticate wireless access for a specific device at a specified data volume and throughput. C-UDM 202 may also provide the user's security certificate to wireline access network 122, for authenticating wireline communication network access for a specific device at a specified service tier. Furthermore, C-UDM 202 may be configured to provide authentication information to one or more additional communication networks (not shown), such as a Wi-Fi communication network, directly or indirectly communicatively coupled to common interface 224, to authenticate the user on such additional communication network. Moreover, linking of multiple authentication information of a given user with a common identification element helps support unified billing and subscriber traffic analysis across different communication networks, as well as facilitates handover of devices across separate communication networks that use different authentication protocols and credentials.

In some embodiments, wireline access network 122 uses a legacy interface 234 for authentication, and an AN authorization proxy 220 bridges legacy interface 234 and common interface 224, to enable wireline access network 122 to communicate with converged core communication network 200 for authentication purposes. Thus, AN authorization proxy 220 translates data between legacy interface 234 and common interface 224. AN authorization proxy 220 may be omitted in embodiments where wireless access network 122 is capable of directly using common interface 224 for authentication purposes.

C-PCF 204 is configured to apply a single traffic management policy across multiple communication networks, e.g. across both a wireless communication network and a wireline communication network, based operator rules and unified subscription information. For example, consider a scenario where UE device 116 executes an application requesting a data session traversing wireless communication link 114. In some embodiments, UE device 116 may send a request for a data session to AMF 212 via logical interface 230, which is, for example, a 5G NG1 logical interface. AMF 212 responds to the data session request by confirming with C-UDM 202 that UE device 116 is authorized to receive the data session, and AMF 212 then cooperates with SMF 218 to launch a user plane function (UPF) 236, which communicates with wireless base station 112 via logical interface 228 to provide the data session traversing wireless communication link 114. Logical interface 228 is, for example, a 5G NG3 logical interface. C-PCF 204 cooperates with wireless base station 112 to apply a predetermined traffic management policy to the data session traversing wireless communication link 114, such as based on a service profile associated with UE device 116 and stored in C-UDM 202, as well as based on operator rules, such traffic policies for pre-defined network slices.

Importantly, converged core communication network 200 shares C-PCF 204 with wireline access network 122, and in certain embodiments, wireline access network 122 uses C-PCF 204 to determine a traffic management policy for data sessions traversing wireline communication links, e.g. wireline communication link 118. For example, consider a scenario where access device 124 executes an application requesting a data session traversing wireline communication link 118. In certain embodiments, access device 124 may send a request for a data session to wireline access network 122. Wireline access network 122 then communicates with C-PCF 204 to obtain traffic policy information for the data session. Wireline access network 122 and SFM 218 cooperate to launch a UPF 240, which communicates with wireline access network 122 via a logical interface 242 to provide a data session from wireline access network 122 to one or more network services. In some embodiments, logical interface 242 is a 5G NG3 logical interface. Wireline access network 112 enforces the traffic policy information obtained from C-PCF on a data session traversing wireline communication link 118, such as based on a service profile associated with access device 124 stored in C-UDM 202, as well as based on operator rules, such traffic policies for pre-defined network slices. Although FIG. 2 illustrates a single SMF 218 generating UPFs for both wireless and wireline communication links, converged core communication network 200 could be modified to have a respective SMF for each communication network type.

AN policy proxy 222 bridges a legacy interface 238 and common interface 224, to enable wireline access network 122 to communicate with converged core communication network 200 for policy enforcement purposes. Thus, AN policy proxy 222 translates data between legacy interface 238 and common interface 224. Legacy interface 238 is, for example, an interface used by wireline access network 122 for policy functions. In some embodiments, legacy interface 238 operates according to a common open policy service (COPS) protocol. AN policy proxy 222 may be omitted in embodiments where wireless access network 122 is capable of directly using common interface 224 for policy enforcement services.

In some embodiments, C-PCF 204 applies a converged traffic policy across data sessions traversing both wireless communication link 114 and wireline communication 118, thereby promoting consistent user experience across both communication links. For example, in embodiments where wireless communication link 114 is a 5G NR data link and wireline communication link 118 is a DOCSIS datalink, C-PCF 204 may be configured enforce a common traffic policy by (a) setting a 5G quality class identifier (QCI) according to the common traffic policy and (b) initiating a DOCSIS service flow according to the common traffic policy. In some embodiments, C-PCF 204 is configured to support two or more simultaneous data sessions on a single device, e.g., UE device 116 or access device 124, such as to provide hybrid access (HA) to the device using two or more different communication link types. For example, in some embodiments, C-PCF 204 is configured to support simultaneous data sessions on UE device 116 and/or access device 124 using UPFs 236 and 240.

C-NSSF 206 is configured to organize specific network segments to create one or more network slices, such as to optimize and/or compartmentalize network capabilities. Importantly, C-NSSF 206 is configured to create a single end-to-end network slice spanning two or more communication networks, e.g. spanning both a wireless communication network and wireline communication network. In particular embodiments, C-NSSF 206 is configured to provide a single QoS traffic management policy, as defined by C-PCF 204, on a single network slice spanning two or more different communication networks, e.g. spanning both wireless communication link 114 and wireline communication link 118. In some embodiments, C-NSSF 206 is configured to generate network slices optimized for a particular application, such as for a high-performance video application or a virtual reality application. Examples of network slices that may be generated by certain embodiments of C-NSSF 206 include, but are not limited to, a mobile broadband slice, a mobile transport slice, an Internet of Things (IoT) slice, a video slice, a VOW slice, and a virtual reality slice.

C-NEF 208 is configured to securely and deliberately expose information on communication networks sharing converged core communication network 200, as well as on users of these networks, to a network analysis function (not shown). For example, in some embodiments, an artificial intelligence (AI) network analysis function may use C-NEF 208 to determine network performance and suggest network configuration changes to improve network performance. Unlike conventional network exposure functions, C-NEF 208 provides information on both the wireless communication network and the wireline communication network sharing converged core communication network 200, thereby enabling information to be obtained on the collective performance of the wireless and wireline communication networks, e.g., on data sessions traversing both networks. Additionally, certain embodiments of C-NEF 208 are configured to provide information for a single user that may include multi-path data flows, e.g. across both wireless and wireline communication links.

C-NRF 210 is configured to support discovery of network services on communication networks sharing converged core communication network 200. In particular embodiments, an application or operator can access C-NRF 210 to discover and leverage network services from both the wireless and wireline networks sharing converged core communication network 200, and in some embodiments, C-NRF 210 can indicate to the application which services on the wireless and wireline networks share common characteristics or can be used together for a common purpose. For example, an application may use C-NRF 210 to identify a network service at least partially supported by wireline communication link 118, or an application may use C-NRF 210 to identify a network service spanning both wireless communication link 114 and wireline communication link 118.

AF 216 is configured to request dynamic policies and/or charging control. In some embodiments, AF 216 is used only for wireless network access. In certain embodiments, AF 216, AMF 212, AUSF 214, and SMF 218 operate according to 5G NR standards.

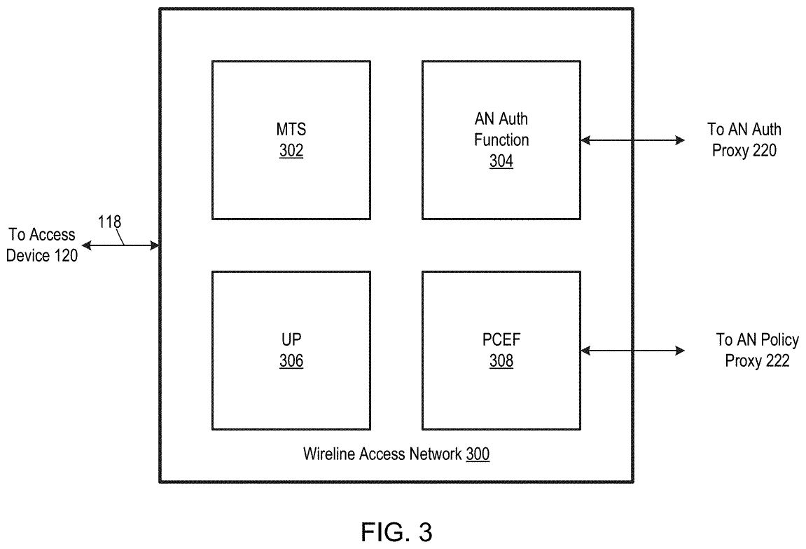

FIG. 3 is a block diagram illustrating a wireline access network 300, which is one possible embodiment of wireline access network 122 of FIG. 2. It should be appreciated, however, that wireline access network 122 could have other configurations without departing from the scope hereof.

Wireline access network 300 includes the following network functions: (a) a modem termination system (MTS), (b) an AN authorization function 304, (c) a user plane (UP) function 306, and (d) a policy charging and enforcement function (PCEF) 308. In some embodiments, wireless access network 300 includes a processing subsystem (not shown) and a memory subsystem (not shown), where the processing subsystem executes instructions stored in the memory subsystem to provide the network functions of wireline access network 300. MTS 302 terminates wireline communication link 118. Examples of MTS 302 include, but are not limited to a CMTS, a DSLAM, an OLT, an optical network terminal, an optical network unit, and a network terminal. However, MTS 302 is not limited to these configurations; to the contrary, MTS 302 can have any configuration as long as it is capable of terminating wireline communication links. In some embodiments, MTS 302 also schedules transfer of data packets among wireline communication link 118. As discussed above, in some embodiments, wireline communication link 118 includes a coaxial cable, an optical cable, a twisted pair cable, or a hybrid of two or more cables, such as a hybrid of an optical cable and a coaxial cable or a hybrid of an optical cable and a twisted pair cable.

AN authorization function 304 authenticates wireline access devices, such as access device 122. In particular embodiments, AN authorization function 304 obtains device and/or user authentication information from C-UDM 202 of converged core communication network 200. User plane (UP) function 306 launches user planes in wireline access network 300, and PCEF 308 enforces traffic policy information obtained from C-PCF 204 on data sessions traversing wireline communication links of wireline access network 300. In some alternate embodiments, UP function 306 is omitted and wireline access network 300 relies solely on user planes created by converged core communication network 200 for data transmission.

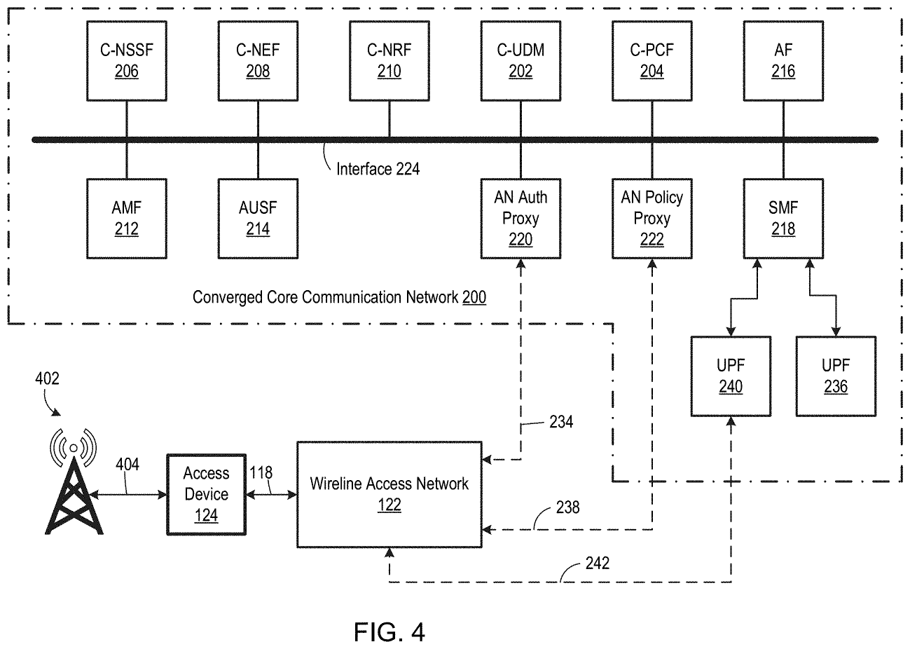

Discussed below with respect to FIGS. 4-7 are several possible applications of converged core communication network 200. It should be realized, though, that converged core communication network 200 is not limited to these example applications.

FIG. 4 is a block diagram of an application of converged core communication network 200 where wireline access network 122 provides a backhaul communication link for a wireless base station 402. A communication link 404, e.g., an electrical, optical, or wireless communication link, communicatively couples wireless base station 402 to access device 124. Wireless base station 402 is, for example, a LTE base station (e.g., an eNB device), a 5G NR base station (e.g., a gNB device), a 6G wireless communication base station, a Wi-Fi base station (e.g., including unscheduled, partially scheduled, and unscheduled systems), or variations and/or extensions thereof. In some embodiments, wireless base station 402 is a “small cell,” i.e. a wireless base station for providing service in small geographic area, such as within a building. In this embodiment, C-NSSF 206 is optionally configured to provide a slice for a data session traversing both wireline communication link 118 and a wireless communication link (not shown) associated with wireless base station 402.

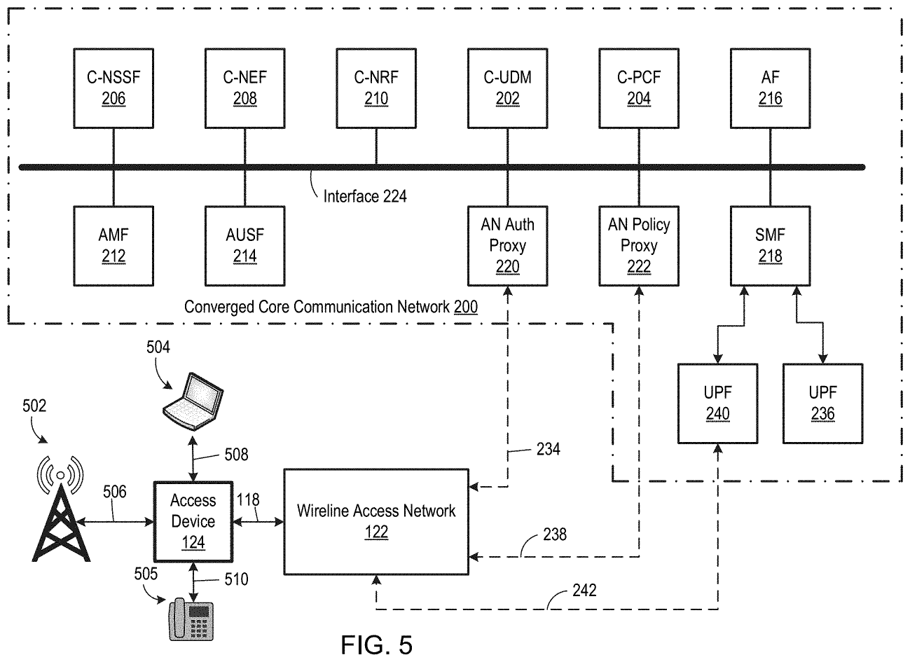

FIG. 5 is a block diagram illustrating an application of converged core communication network 200 where wireline access network 122 provides (1) backhaul for a small cell wireless base station 502 and (2) broadband Internet access, such as for one or more UE devices 504. Additionally, wireless access network 122 optionally also provides support for fixed voice service via a telephone 505. In this embodiment, access device 124 is implemented, for example, by a premises gateway that includes networking functionality in addition to wireline communication network access. The premises gateway may be referred to as a “home gateway” or a “residential gate” in applications intended for residential use. However, the FIG. 5 example application is not limited to residential use.

A communication link 506, e.g., an electrical, optical, or wireless communication link, communicatively couples wireless base station 502 to access device 124. Wireless base station 502 is, for example, a small cell LTE base station (e.g., an eNB device), a small cell NR base station (e.g., a gNB device), a small cell 6G wireless communication base station, a Wi-Fi base station (e.g., including unscheduled, partially scheduled, and unscheduled systems), or variations and/or extensions thereof. A communication link 508 (e.g., wireline or wireless) communicatively couples UE device 504 with access device 124, and a communication link 510 (e.g., wireline or wireless) communicatively couples optional telephone 505 with access device 124.

In this embodiment, C-UDM 202 optionally includes a subscription profile associated with access device 124 that includes fixed broadband service, mobile telephone service, and wireless service, where the wireless service is provided by small cell wireless base station 502. Additionally, C-UDM 202 optionally includes a subscription profile associated with access device 124 that includes fixed voice service for telephone 505 in embodiments supporting such service. C-NSSF 206 is optionally configured to provide respective slices for each of these services, with optional QoS traffic management policy for these slices. For example, C-NSSF 206 may be configured to provide one or more of the following slices: (a) a slice spanning wireline communication link 118 and a wireless communication link (not shown) associated with wireless base station 502 for mobile broadband service, (b) a slice spanning wireline communication link 118 and a wireless communication link (not shown) associated with wireless base station 502 for mobile voice service, (c) a slice spanning wireline communication link 118 for fixed broadband service, and (d) a slice spanning wireline communication link 118 for fixed voice service.

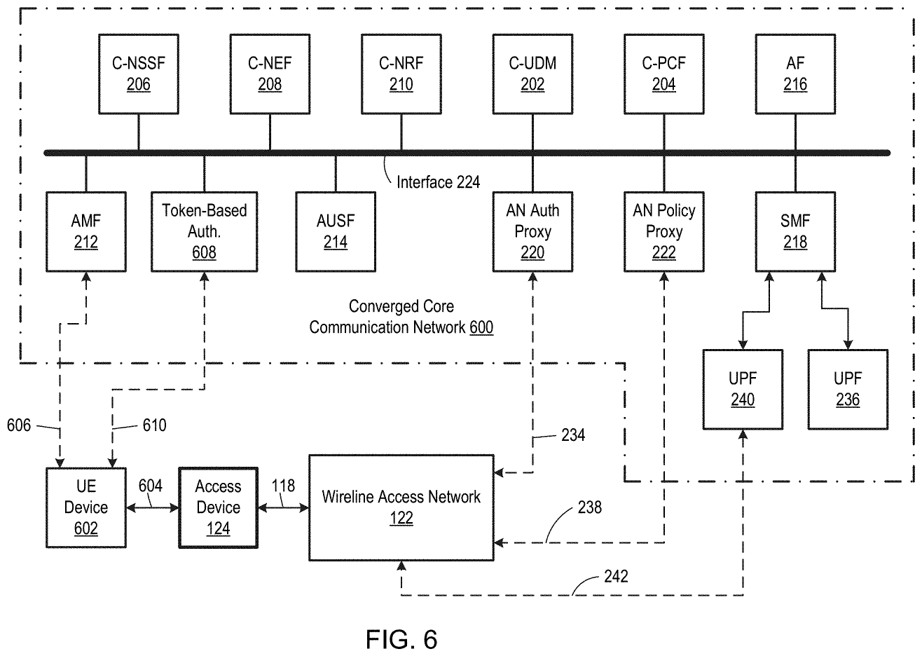

Some wireline access networks may have limited ability (or no ability) to control client UE devices. Accordingly, in some embodiments, converged core communication network 200 is configured to control UE devices served by wireline access network 122. For example, FIG. 6 is a block diagram illustrating a converged core communication network 600 capable of controlling a UE device 602 served by wireline access network 122. UE device 602 is communicatively coupled to access device 124 via a communication link 604 which is, for example, a wired and/or wireless communication link. Converged core communication network 600 is similar to converged core communication network 200 of FIG. 2, but converged core communication network 600 is further configured to control UE device 602. Is should be noted that UE device 602 need not necessarily be a device designed for use on a wireless communication network; instead UE device 602 could be any one of a computer, a set-top device, a data storage device, an Internet of Things (IoT) device, an entertainment device, a wireless access point (including, for example, eNBs, gNBs, and Wi-Fi APS acting as UEs), a computer networking device, a mobile telephone, a smartwatch, a wearable device with wireless capability, or a medical device, for example.

UE device 602 is logically connected to AMF 212 via a logical link 606, and in some embodiments, logical link 606 is 5G N1G logical link. Converged core communication network 600 controls UE device 602 in manner similar to how converged core communication network 200 controls UE device 116, e.g., using 5G NR techniques. However, in some applications, UE device 602 may use token or certificate-based authentication, instead of authentication based on an IMSI and an AKA. Therefore, converged core communication network 600 optionally includes a token-based authentication 608 network function for authenticating an UE device 602 that requires a token or certificate for authentication. Token-based authentication 608 obtains the token/certificate for UE device 602, for example, from C-UDM 202, and token-based authentication 608 interacts with UE device 602 via a logical link 610.

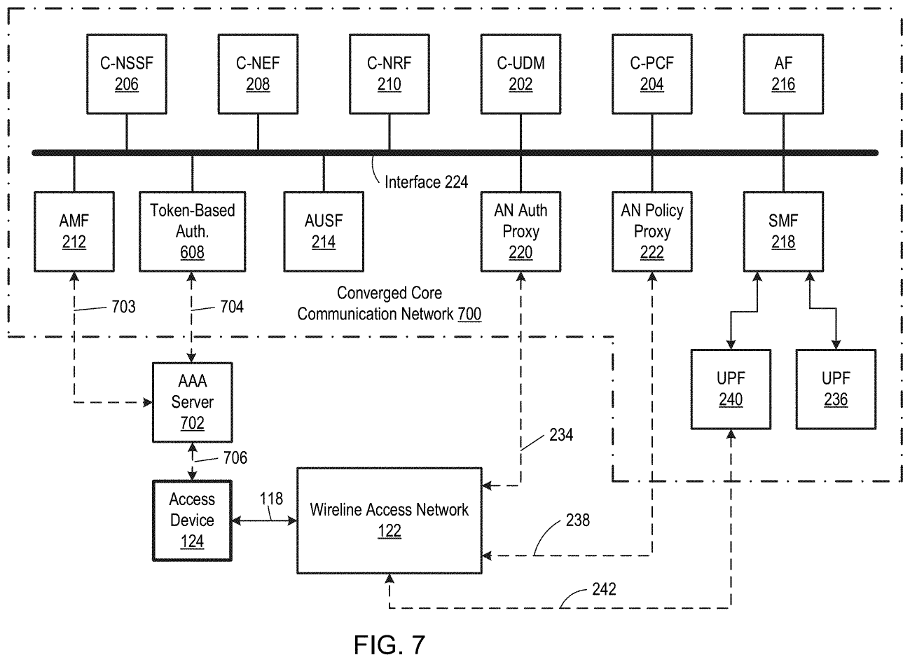

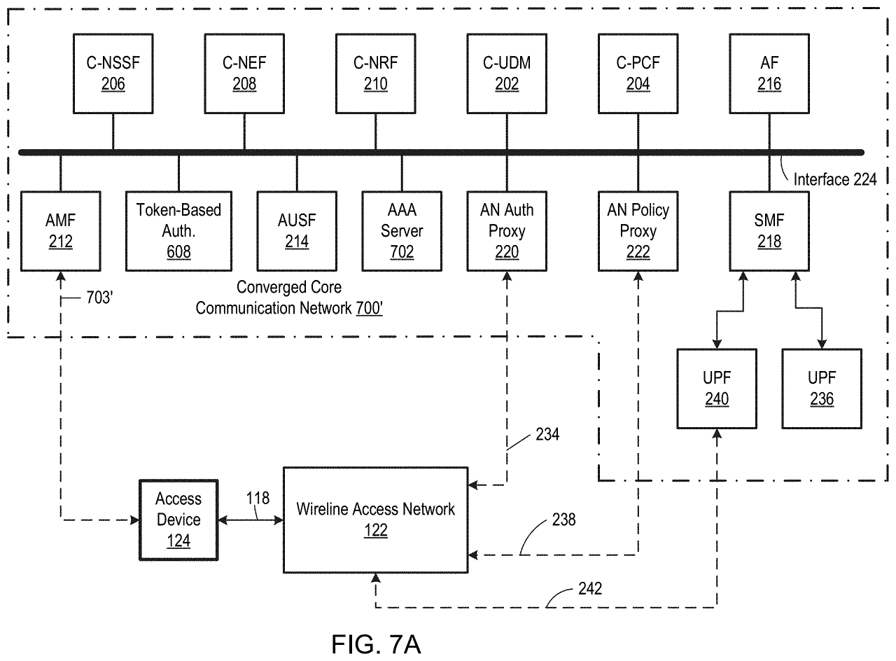

In some embodiments, converged core communication network 200 is configured to control access device 124, e.g. in embodiments where access device 124 is embodied as a premises gateway. For example, FIG. 7 is a block diagram illustrating a converged core communication network 700 that is capable of controlling access device 124 as if access device 124 were a UE device. Converged core communication network 700 is similar to converged core communication network 600 of FIG. 6. For example, converged core communication network 700 also includes token-based authentication 608 network function for authenticating access device 124 in embodiments where access device 124 requires a token or certificate for authentication. Access device 124 is authenticated and controlled in this embodiment via converged communication network 700 as if access device 124 were an UE device. For example, AMF 212, C-UDM 202, and SMF 218 collectively instantiate data sessions requested by access device 124. As another example, C-PCF 204 specifies a traffic policy for enforcement by access device 124.

However, access device 124 does not use the same protocols as converged core communication network 700. Therefore, an authentication, authorization, and accounting (AAA) server 702 is included to translate control information between converged core communication network 700 and access device 124. AAA server 702 is communicatively coupled to converged core communication network 700 by logical links 703 and 704, and AAA 702 is communicatively coupled to access device 702 by a logical link 706. In some embodiments, logical link 703 is a 5G N1 logical link, and logical link 706 is AAA logical link, and AAA server 702 translates between 5G N1 protocols and AAA protocols.

FIG. 7A is a block diagram of a converged core communication network 700′, which is an alternate embodiment of converged core communication network 700 where AAA server 702 is incorporated within the converged core communication network and is communicatively coupled to common interface 224. In this embodiment, access device 124 reaches AAA server 702 via a logical link 703′.

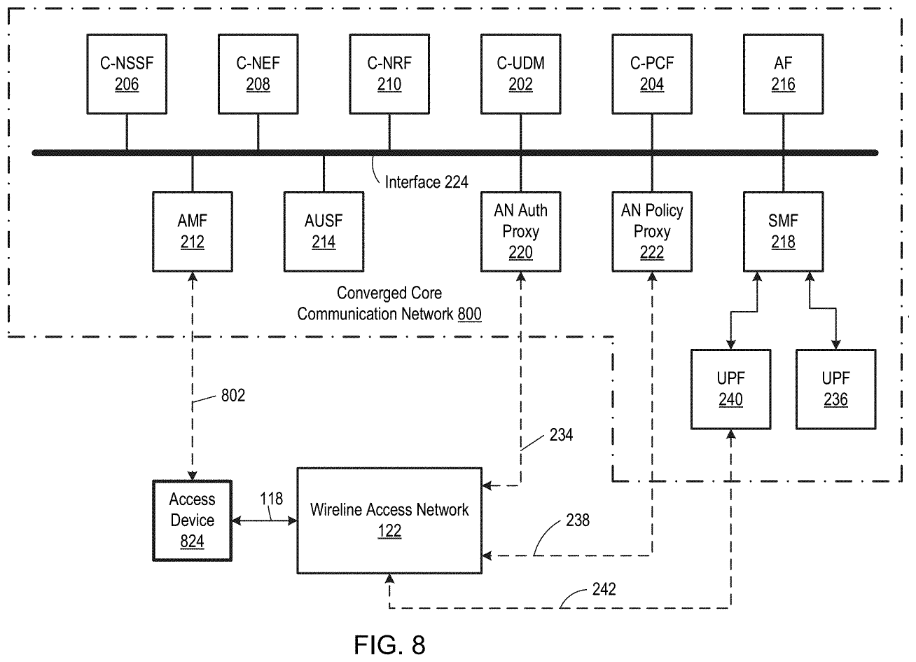

In some embodiments, access device 124 is configured to operate with the same protocols as converged core communication network 200, and in these embodiments, AAA server 702 may be omitted. FIG. 8 illustrates one such embodiment. Specifically, FIG. 8 is a block diagram illustrating a converged core communication network 800 that is capable of controlling an access device 824, where access device 824 is an embodiment of access device 124 that uses the same protocols as converged core communication network 800. Converged core communication network 800 is similar to converged core communication network 700 but with token-based authentication 608 omitted. In some embodiments, access device 824 communicates with converged core communication network 800 via a logical link 802 to AMF 212, where logical link 802 is, for example, a 5G N1G logical link. Converged core communication network 800 controls access device 824 as if it were a wireless UE device, e.g. using 5G NR techniques. For example, AMF 212, C-UDM 202, and SMF 218 collectively instantiate data sessions requested by access device 824. As another example, C-PCF 204 specifies a traffic policy for enforcement by access device 824.

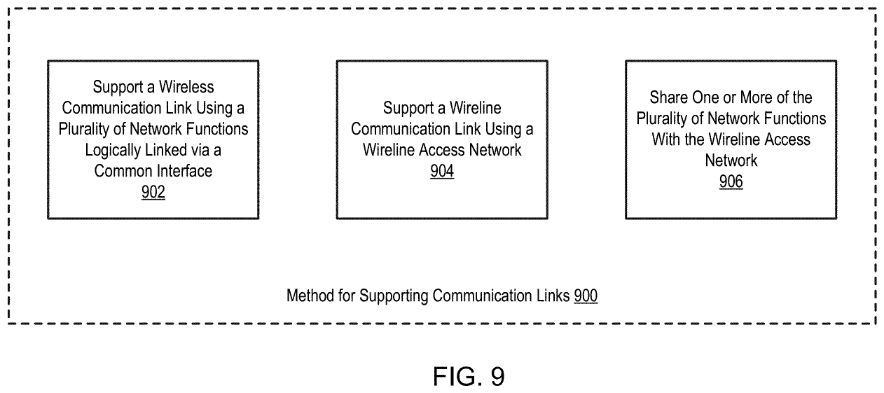

FIG. 9 is a block diagram illustrating a method 900 for supporting communication links, according to an embodiment. In a block 902, a wireless communication link is supported using a plurality of network functions logically linked via a common interface. In one example of block 902, networks functions C-UDM 202, C-PCF 204, C-NSSF 206, C-NEF 208, C-NRF 210, AMF 212, AUSF 214, AF 216, and SMF 218 of converged core communication network 200 support wireless communication link 114. In a block 904, a wireline communication link is supported using a wireline access network. In one example of block 904, wireline access network 122 supports wireline communication link 118. In a block 906, one or more of the plurality of network functions are shared with the wireline access network. In one example of block 906, networks functions C-UDM 202, C-PCF 204, C-NSSF 206, C-NEF 208, and C-NRF 210 of converged core communication network 200 are shared with wireline access network 122. Blocks 902, 904, and 906 may be executed concurrently or at different times without departing from the scope hereof.

A core communication network implements both a control plane and a user plane. A control plane is a logical portion of the core communication network configured to control an access network, and a user plane is a logical portion of the core communication network configured to handle data transmission in the access network. For example, C-UDM 202, C-PCF 204, C-NSSF 206, C-NEF 208, C-NRF 210, AMF 212, AUSF 214, AF 216, SMF 218, AN authentication proxy 220, and AN policy proxy 222 of converged core communication network 200 (FIG. 2) collectively establish a control plane, and UPFs 236 and 240 of converged core communication network 200 collectively establish a user plane. Converged core communication networks 200, 600, 700, and 800 advantageously enable a single control plane to at least partially control both a wireless access network and a wireline access network.

For example, the control plane of converged core communication network 200 supports both wireless communication link 114 and wireline communication link 118. As another example, C-UDM 202, C-PCF 204, C-NSSF 206, C-NEF 208, C-NRF 210, AMF 212, AUSF 214, AF 216, SMF 218, AN authentication proxy 220, AN policy proxy 222, and token-based authentication 608 network function of converged core communication network 600 collectively establish a control plane that supports wireless communication link 114, wireline communication link 118, and UE device 602. Use of a common control plane to support multiple access networks may advantageously simplify access network configuration and maintenance, as well as provide consistent service among multiple access networks. For example, some embodiments of converged core communication networks 200, 600, 700, and 800 enable wireline access network 122 to support one or more features of a wireless access network.

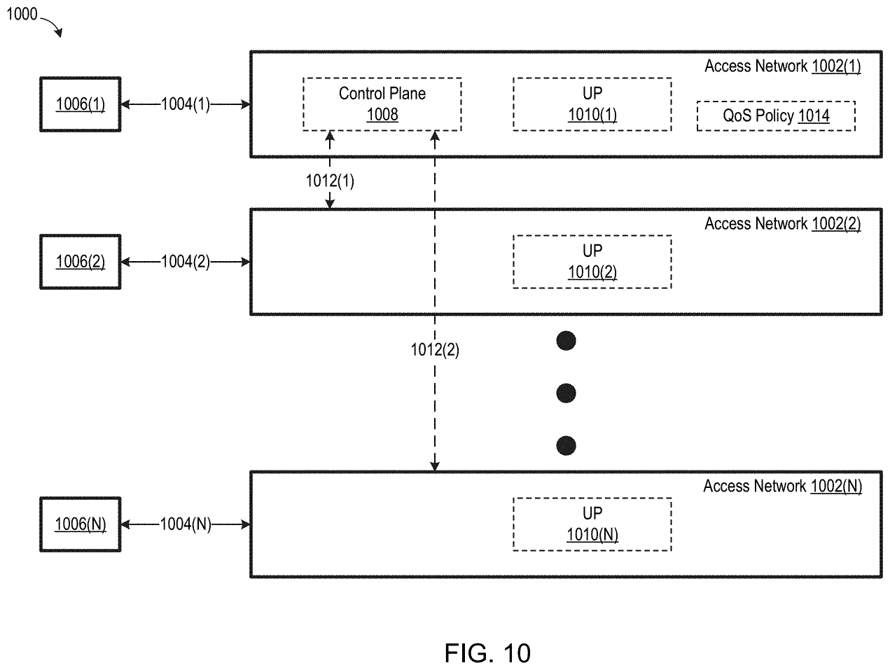

The concept of using a single control plane to control a plurality of access networks is not limited to the converged core communication network examples discussed above. Rather, the concept can be applied to essentially any access network with appropriate configuration of the access network and/or control plane. For example, FIG. 10 is a block diagram of a communication system 1000 including N access networks 1002, where N is an integer greater than one. In this document, specific instances of an item may be referred to by use of a numeral in parentheses (e.g., access network 1002(1)) while numerals without parentheses refer to any such item (e.g., access networks 1002). Although FIG. 10 depicts N being greater than two, N could be equal to two without departing from the scope hereof.

Each access network 1002 is a communication network which provides communication service to one or more clients, such as to UE devices or access devices. Examples of an access network 1002 include, but are not limited to, (1) a 4G wireless access network, (2) a 5G wireless access network, (3) a 6G wireless access network, (4) an Institute of Electrical and Electronics Engineers (IEEE) 802-11 wireless access network, such as a Wi-Fi network, including one or more of an unscheduled, partially scheduled, and scheduled network, (5) a cable access network, such as a cable access network operating according to a DOCSIS protocol, (6) an optical access network, such as an optical access network operating according to one or more of an EPON protocol, a GPON protocol, and a RFOG protocol, (7) a DSL access network, and (8) variations, combinations, and/or extensions of the foregoing access networks. In some embodiments, two or more of access networks 1002 are different types of access networks. For example, in particular embodiments, access network 1002(1) is a wireless access network, and access network 1002(2) is a wireline access network.

Each access network 1002 supports a respective communication link 1004 with one or more devices 1006. Each communication link 1004 is, for example, a wired communication link, a wireless communication link, or a hybrid wired-wireless communication link. Each device 1006 is, for example, a UE device or an access device. Examples of devices 1006 include, but are not limited to, a computer, a set-top device, a data storage device, an Internet of Things (IoT) device, an entertainment device, a wireless access point (including, for example, eNBs, gNBs, and Wi-Fi APS acting as UEs), a computer networking device, a mobile telephone, a smartwatch, a wearable device with wireless capability, a medical device, a cable modem (e.g. operating according to a DOCSIS protocol), a DSL modem, an optical network unit (ONU) or an optical network terminal (ONT) (e.g., operating according to an EPON protocol, a RFOG protocol, or a GPON protocol), or any other device capable of terminating a communication link 1004. Each communication link 1004 need not have the same configuration, and each device 1006 need not have the same configuration. Additionally, one or more devices 1006 can include multiple sub-elements, such as an access device and a UE device served thereby.

Although each access network 1002 is depicted for illustrative simplicity as supporting only a single communication link 1004, one or more access networks 1002 could be configured to support a plurality of communication links 1004 without departing from the scope hereof. For example, some embodiments of access networks 1002 are capable of supporting hundreds, thousands, tens of thousands, or even more communication links 1004. Similarly, while each access network 1002 is illustrated as supporting only a single device 1006 for illustrative clarity, each access network 1002 could support additional devices 1006 without departing from the scope hereof.

Access network 1002(1) implements a control plane 1008. In some embodiments, access network 1002(1) includes a converged core communication network, such as one of the converged core communication networks discussed above, implementing control plane 1008. However, control plane 1008 may be implemented in other manners without departing from the scope hereof. In some embodiments, one or more of access networks 1002(2)-1002(N) also implements as respective control plane (not shown). Each access network 1002 additionally implements a respective user plane 1010. In some embodiments, one or more of user planes 1010 are implemented by one of the converged core communication networks discussed above. However, user planes 1010 may be implemented in other manners without departing from the scope hereof. Furthermore, in some alternate embodiments, one or more of access networks 1002(2)-1002(N) does not implement a respective user plane 1010.

Access networks 1002 are collectively configured such that control plane 1008 of access network 1002(1) at least partially controls each access network 1002. For example, control plane 1008 at least partially controls each access network 1002 by supporting its respective communication links 1004. Examples of how control plane 1008 may support a communication link 1004 include, but are not limited to, one or more of establishing the communication link 1004, terminating the communication link 1004, authenticating the communication link 1004, authenticating a device 1006 served by the communication link 1004, controlling parameters of the communication link 1004 (e.g., bandwidth, latency, QoS, network services available via the communication link, etc.), controlling traffic on the communication link 1004, and discovering a service requested by a device 1006 served by the communication link 1004. Control plane 1008 establishes a control plane logical link 1012 with each of access networks 1002(2)-1002(N) to at least partially control the access network 1002, e.g. to support communication links 1004 of the access network 1002. One of more of control plane logical links 1012 may include a plurality of logical links, such as a 5G NR NG1 logical link, a 5G NR NG2 logical link, and/or a 5G NR NG3 logical link.

In some embodiments, two or more access networks 1002 are collectively configured to implement a common QoS traffic management policy on the access networks 1002, where QoS prioritizes transportation of data packets that are high-priority, e.g. time sensitive data packets, over data packets that are not high priority. For example, in some embodiments, access networks 1002 are configured such that a QoS traffic management policy 1014 of access network 1002(1) is implemented on access networks 1002(2)-1002(N). QoS traffic management policy 1014 is implemented on access networks 1002(2)-1002(N), for example, by selecting service flows of access networks 1002(2)-1002(N) according to QoS traffic management policy 1014. For instance, if QoS traffic management policy 1014 specifies that communication link 1004(2) is to receive priority processing, access network 1002(2) may select a high priority service flow for communication link 1004(2). Additionally, some embodiments of access networks 1002(2)-1002(N) are configured to create one or more service flows to implement QoS traffic management policy 1014, if requisite service flow(s) do not already exist in access networks 1002(2)-1002(N). In certain embodiments, QoS is determined according to one or more of (1) a device 1006 identifier (e.g. media access control address of a device 1006), (2) identity of a local area network or virtual local area network serving a device 1006, (3) differentiated services field codepoints (DSCP), (4) source IP address and/or source port, (5) destination IP address and/or destination port, (6), type of communication medium(s) associated with a communication link 1004 and/or a device 1006, and (7) vendor-specific features associated with a communication link 1004 and/or a device 1006.

In some embodiments, access networks 1002 are further collectively configured so that communication interfaces of two or more access networks 1002 may support a given device 1006. For example, in particular embodiments where access network 1002(1) is a wireless access network and access network 1002(2) is a wireline access network, device 1006(2) may be supported by a radio communication interface of access network 1002(1) and/or a wireline communication interface of access network 1002(2). In some of these embodiments, one or more of access networks 1002(1) and 1002(2) are configured to select between the radio air communication interface and the wireline communication interface to support device 1006(2), such as to achieve a desired load balancing among access networks 1002(1) and 1002(2). Additionally, in certain of these embodiments, one or more of access networks 1002(1) and 1002(2) are configured to cause the radio and wireline communication interfaces to simultaneously support device 1006(2), such as to achieve high throughput for device 1006(2).

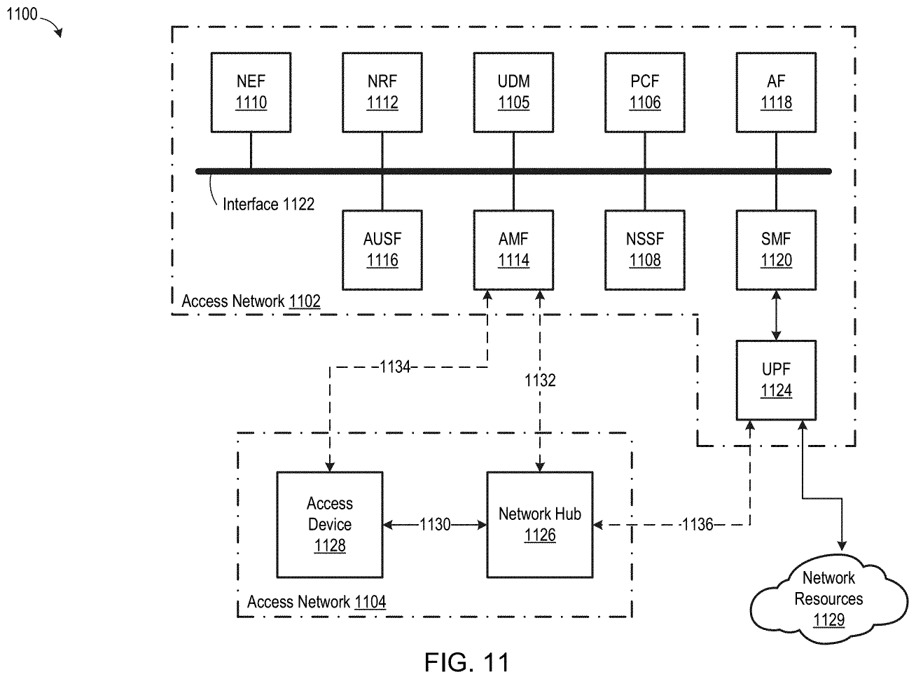

FIG. 11 is a block diagram of a communication system 1100, which is an embodiment of communication system 1000 (FIG. 10) where N is equal to two. Communication system 1100 includes an access network 1102 and an access network 1104, which are each an embodiment of access network 1002. Access network 1102 includes a (1) a unified data management (UDM) 1105, (2) a policy control function (PCF) 1106, (3) a network slice function (NSSF) 1108, (4) a network exposure function (NEF) 1110, (5) a network repository function (NRF) 1112, (6) an AMF 1114, (7) an AUSF 1116, (8) an AF 1118, and (9) a SMF 1120. These network functions are logically linked via a common interface 1122, and these network functions collectively form a control plane of access network 1102. The control plane at least partially controls each of access network 1102 and access network 1104. In some embodiments, common interface 1122 is configured according to a REST API, although common interface 1122 could take other forms without departing from the scope hereof. Access network 1102 further includes a UPF 1124 which implements a user plane. Access network 1102 can (and typically will) include additional elements, such as wireless base stations and/or other access devices, which are not shown in FIG. 11 to promote illustrative clarity.

UDM 1105 holds service profiles for devices and users, e.g. for devices and users of access networks 1102 and 1104. The service profiles include, for example, identities and properties of authorized devices and/or users, as well as listings of network services and/or network service levels associated with the devices and/or users. In some embodiments, AUSF 1116 uses authentication information from UDM 1105 to authenticate access to both of access networks 1102 and 1104. In some other embodiments, AUSF 1116 is configured to obtain authentication information from UDM 1105 to authenticate access on access network 1102, but access network 1104 handles its own authentication. In these embodiments, access network 1104 optionally obtains authentication information from UDM 1105 to perform authentication. PCF 1106 is configured to apply a traffic management policy, e.g. across both access networks 1102 and 1104, based operator rules and unified subscription information. In some embodiments, a UE device (not shown) served by access network 1102 or 1104 may send a request for a data session to AMF 1114, and AMF 1114 responds to the data session request by confirming with UDM 1105 that the UE device is authorized to receive the data session. AMF 1114 then cooperates with SMF 1120 to launch UPF 1124, which provides the data session for the UE device. Although FIG. 11 depicts a single UPF 1124 serving both of access networks 1102 and 1104, in some embodiments, SMF 1120 launches one or more respective UPFs for each of access networks 1102 and 1104.

NSSF 1108 is configured to organize specific network segments to create one or more network slices, such as to optimize and/or compartmentalize network capabilities. In some embodiments, NSSF 1108 is configured to generate network slices optimized for a particular application, such as for a high-performance video application or a virtual reality application. NEF 1110 is configured to securely and deliberately expose information on access networks 1102 and 1104, as well as on users of these access networks, to a network analysis function (not shown). NRF 1112 is configured to support discovery of network services available to access networks 1102 and 1104. AF 1118 is configured to request dynamic policies and/or charging control. In some embodiments, one or more of UDM 1105, PCF 1106, NSSF 1108, NEF 1110, and NRF 1112 are converged network functions, such as one or more of the converged network functions discussed above with respect to FIG. 2.

Access network 1104 includes a network hub 1126 and an access device 1128, where access device 1128 is communicatively coupled to network hub 1126 via a communication link 1130. Network hub 1126 is configured to interface access devices, such as access device 1128, with network resources 1129 via UPF 1124 and/or other UPFs (not shown). Examples of network resources 1129 include, but are not limited to, the public Internet, voice communication applications, conferencing applications, and/or content delivery applications. In particular embodiments, network hub 1126 includes a wireless or wired relay node, an Ethernet switch, a CMTS, an OLT, a wireless communication termination system (e.g. a packet core or an evolved packet core), a wireless relay system, or a DSLAM. Although network hub 1126 is depicted as a single element, in some embodiments, network hub 1126 includes a plurality of elements, such as a central element and one or more remote elements. For example, in some embodiments, network hub 1126 includes a CMTS and one or more fiber nodes, and in some other embodiments, network hub 1126 includes an OLT and one or more splitters. Accordingly, network hub 1126 could include elements in a plurality of different locations.

Access device 1128 is, for example, configured to interface one or more UE devices (not shown) with network hub 1126. In some embodiments, access device 1128 includes a modem, such as a cable modem, a DSL modem, an ONT, or an ONU. In embodiments where access device 1128 includes a cable modem, the cable modem optionally operates according to a DOCSIS protocol. In embodiments where access device 1128 includes an ONT or an ONU, the ONT or ONU optionally operates according to an EPON protocol, a RFOG protocol, or a GPON protocol. In certain embodiments, access device 1128 includes a wireless access device (including, for example an eNB, a gNB, an IEEE 802.11-based wireless access point, an Integrated Access and Backhaul (IAB) access point, a microcell, a picocell, a femtocell, a macrocell, and an IEEE 802.11-based application, etc). However, access device 1128 can take other forms without departing from the scope hereof.

Communication link 1130 includes, for example, electrical cable (e.g. coaxial electrical cable and/or twisted-pair electrical cable), optical cable, and/or a wireless communication link. In some embodiments, communication link 1130 communicatively couples multiple access devices 1128 (not shown) with network hub 1126. Although network hub 1126, access device 1128, and communication link 1130 are depicted as being separate elements, in some embodiments, two or more of these elements are combined or interspersed together. For example, in some embodiments where (1) network hub 1126 includes a CMTS and fiber nodes and (2) communication link 1130 includes optical cable and coaxial electrical cable, the fiber nodes of network hub 1126 are interspersed with optical cable and coaxial electrical cable of communication link 1130.

The control plane of access network 1102 controls access network 1104 at least partially via control plane logical links 1132 and 1134. Control plane logical link 1132 communicatively couples AMF 1114 and network hub 1126 for control purposes, and control plane logical link 1134 communicatively couples AMF 1114 and access device 1128 for control purposes. Accordingly, network hub 1126 and access device 1128 are each configured to be at least partially controlled by the user plane of access network 1102 via control plane logical links 1132 and 1134, respectively. In some embodiments, control plane logical links 1132 and 1134 are 5G NR N1G and 5G NR N2G logical links, respectively. Network hub 1126 communicates with UPF 1124 via a user plane logical link 1136 to exchange data with network resources 1129. In some embodiments, user plane logical link 1136 is a 5G NR N3G logical link.

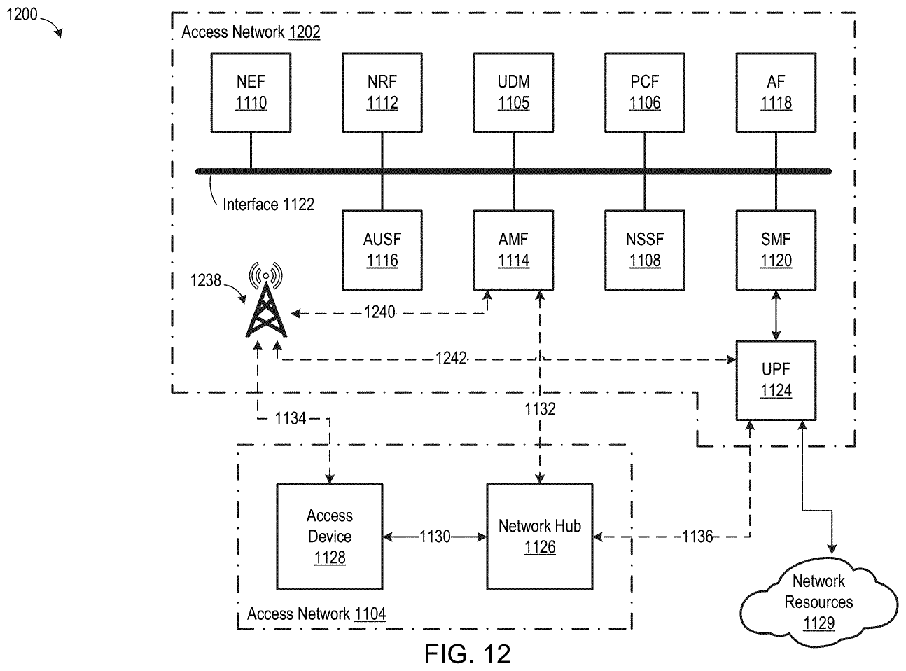

FIG. 12 is a block diagram of a communication system 1200, which is an embodiment of communication system 1100 where access network 1102 is embodied by an access network 1202. Access network 1202 includes a wireless base station 1238, along with the elements of access network 1102 illustrated in FIG. 11. Wireless base station 1238 is, for example, an eNB, a gNB, an IEEE 802.11-based wireless access point, an IAB access point, a microcell, a picocell, a femtocell, a macrocell, or an IEEE 802.11-based application. Wireless base station 1238 is communicatively coupled to AMF 1114 via a control plane logical link 1240, and wireless base station 1238 is communicatively coupled to UPF 1124 via a user plane logical link 1242. Access device 1128 is communicatively coupled to AMF 1114 via control plane logical link 1134, by way of wireless base station 1238 and control plane logical link 1240. In some embodiments, control plane logical link 1134 is a 5G NR N1G logical link, control plane logical link 1240 is a 5G NR N2G logical link, and user plane logical link 1242 is a 5G NR N3G logical link.

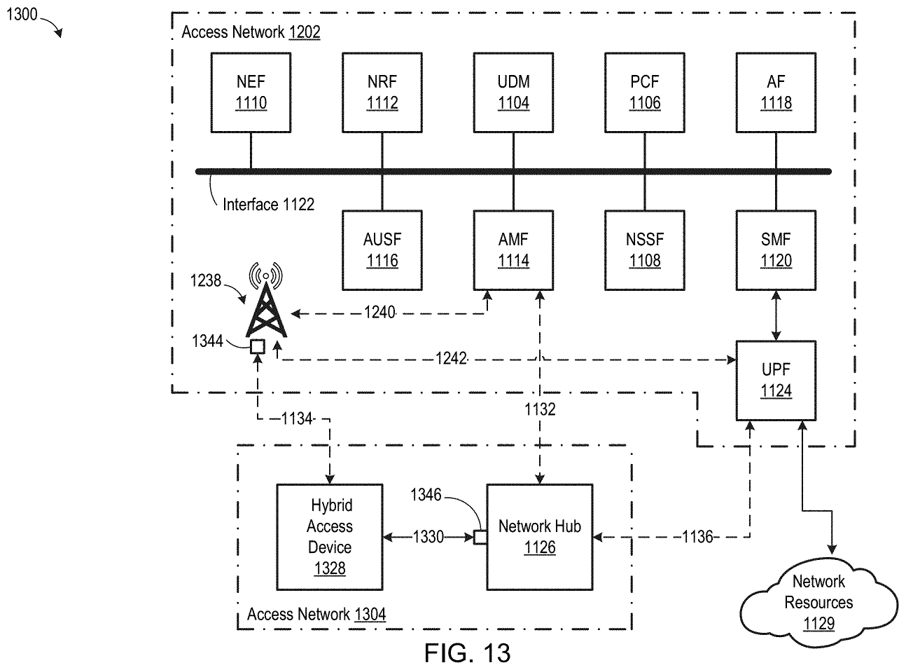

FIG. 13 is a block diagram of a communication system 1300, which is an embodiment of communication system 1300 where access network 1104 is embodied by an access network 1304. In access network 1304, (1) communication link 1130 is embodied by a wireline communication link 1330 having a wireline communication interface 1346, and (2) access device 1128 is embodied by a hybrid access device 1328 capable of simultaneously (a) connecting to a radio communication interface 1344 of access network 1202 and (b) connecting to wireline communication interface 1346 of access network 1304. Consequentially, data can be transmitted between access device 1328 and network resources 1129 by simultaneously using radio communication interface 1344 and wireline communication interface 1346, such as to maximize throughput of access device 1328. Additionally, in certain embodiments of system 1300, access network 1202, access network 1304, and/or hybrid access device 1328 are configured to select between radio communication interface 1344 and wireline communication interface 1346 when transmitting data between access device 1328 and network resources 1129, such as to achieve load balancing among access networks 1202 and 1304.

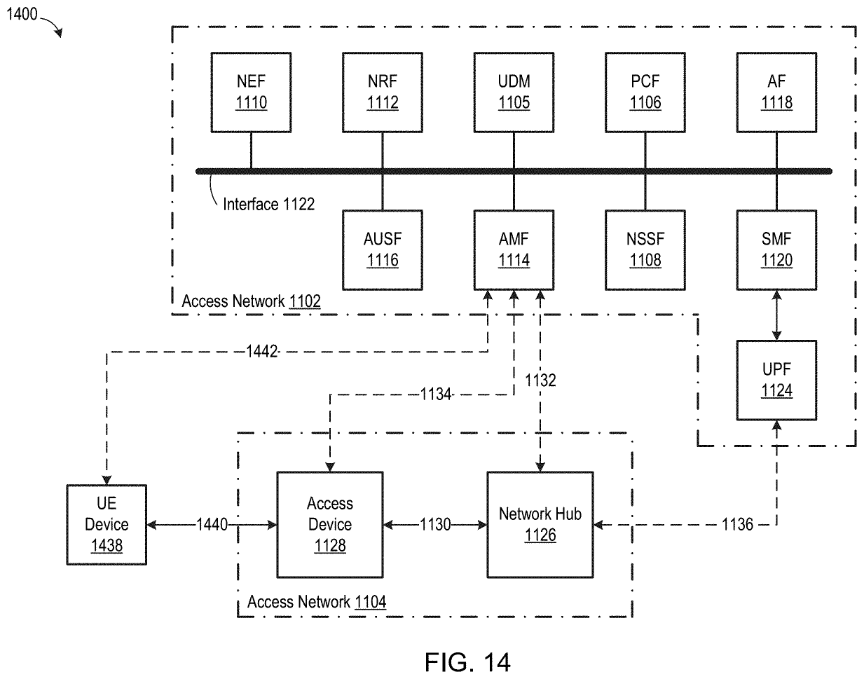

FIG. 14 is a block diagram of a communication system 1400, which is an embodiment of communication system 1100 (FIG. 11) where access device 1104 supports a UE device 1438, and UE device 1438 is communicatively coupled to access device 1128 via a communication link 1440. UE device 1438 is, for example, a mobile telephone, a computer, a set-top device, a data storage device, an IoT device, an entertainment device, a computer networking device, a smartwatch, a wearable device with wireless capability, a medical device, or a wireless access device (including, for example an eNB, a gNB, an IEEE 802.11-based wireless access point, an IAB access point, a microcell, a picocell, a femtocell, a macrocell, and an IEEE 802.11-based application, etc). However, UE device 1438 can take other forms without departing from the scope hereof. Communication link 1440 is, for example, a wireline communication link, a wireless communication link, or a hybrid wireline-wireless communication link.

UE device 1438 can communicate with the control plane of access network 1102 via a direct control plane logical link 1442 to AMF 1114. In some embodiments, control plane logical link 1442 is a 5G NR N1G logical link. Accordingly, the control plane of access network 1102 can at least partially control UE device 1438 via control plane logical link 1442.

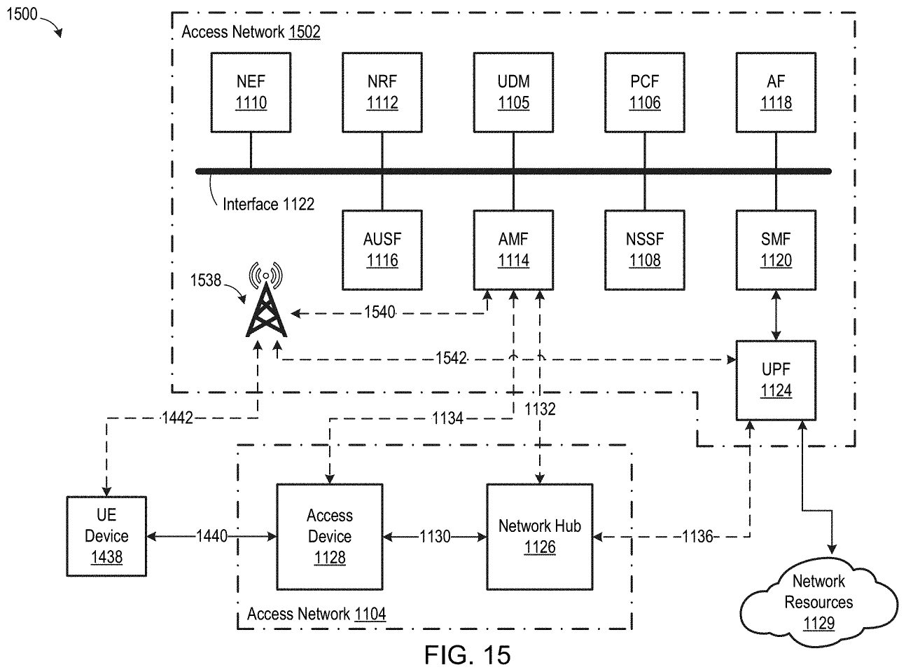

FIG. 15 is a block diagram of a communication system 1500, which is an embodiment of communication system 1400 (FIG. 14) where access network 1102 is embodied by an access network 1502. Access network 1502 includes a wireless base station 1538, along with the elements of access network 1102 illustrated in FIG. 11. Wireless base station 1538 is, for example, an eNB, a gNB, an IEEE 802.11-based wireless access point, an IAB access point, a microcell, a picocell, a femtocell, a macrocell, or an IEEE 802.11-based application. Wireless base station 1538 is communicatively coupled to AMF 1114 via a control plane logical link 1540, and wireless base station 1538 is communicatively coupled to UPF 1124 via a user plane logical link 1542. UE device 1438 is communicatively coupled to AMF 1114 via control plane logical link 1442, by way of wireless base station 1538 and control plane logical link 1540. In some embodiments, control plane logical link 1442 is a 5G NR N1G logical link, control plane logical link 1540 is a 5G NR N2G logical link, and user plane logical link 1542 is a 5G NR N3G logical link.

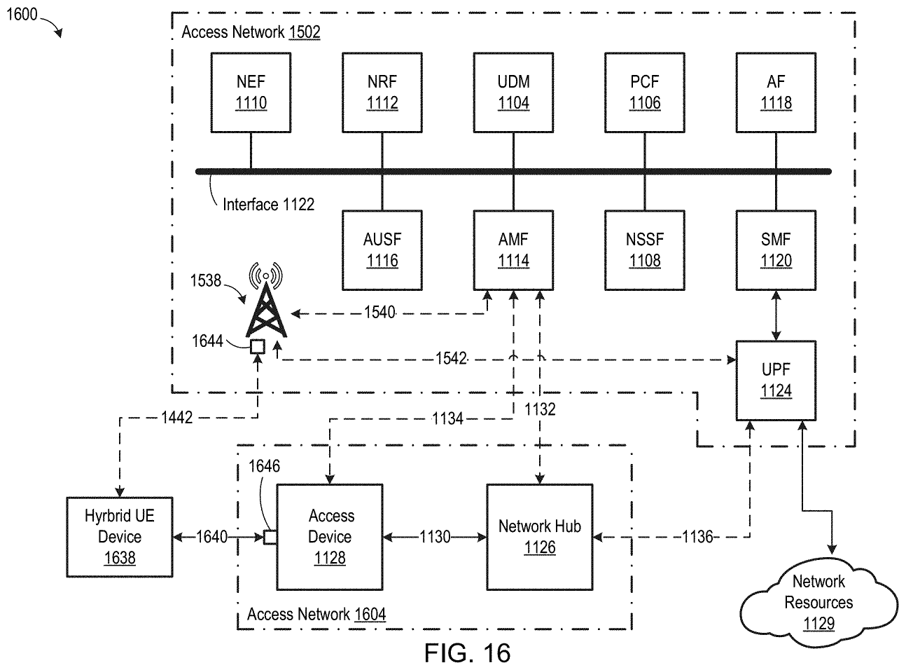

FIG. 16 is a block diagram of a communication system 1600, which is an embodiment of communication system 1500 where access network 1104 is embodied by an access network 1604. In access network 1604, communication link 1440 is embodied by a wireline communication link 1640 having a wireline communication interface 1646. Additionally, UE device 1438 is embodied by a hybrid access device 1638 capable of simultaneously (a) connecting to a radio communication interface 1644 of access network 1502 and (b) connecting to wireline communication interface 1646 of access network 1604. Consequentially, data can be transmitted between UE device 1638 and network resources 1129 by simultaneously using radio communication interface 1644 and wireline communication interface 1646, such as to maximize throughput of UE device 1638. Additionally, in certain embodiments of system 1600, access network 1502, access network 1604, and/or hybrid access device 1638 are configured to select between radio communication interface 1644 and wireline communication interface 1646 when transmitting data between UE device 1638 and network resources 1129, such as to achieve load balancing among access networks 1502 and 1604.

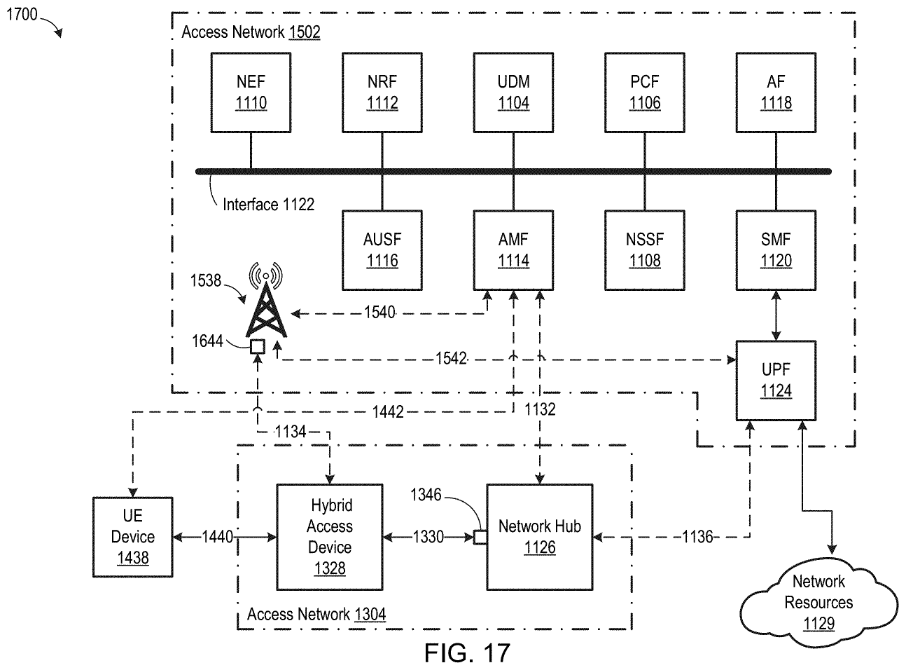

FIG. 17 is a block diagram of a communication system 1700, which is an embodiment of communication system 1400 where (1) where access network 1102 is embodied by an access network 1502 of FIG. 15, and (2) access network 1104 is embodied by access network 1304 of FIG. 13. Access device 1328 is communicatively coupled to AMF 1114 via control plane logical link 1134, by way of wireless base station 1538 and control plane logical link 1540, such that the control plane of access network 1502 is configured to at least partially control access device 1328. Additionally, data can be transmitted between access device 1328 and network resources 1129 by simultaneously using radio communication interface 1644 and wireline communication interface 1346, in a manner similar to that discussed above with respect to FIG. 13. Additionally, in certain embodiments of system 1700, access network 1502, access network 1304, and/or hybrid access device 1328 are configured to select between radio communication interface 1644 and wireline communication interface 1346 when transmitting data between access device 1328 and network resources 1129.

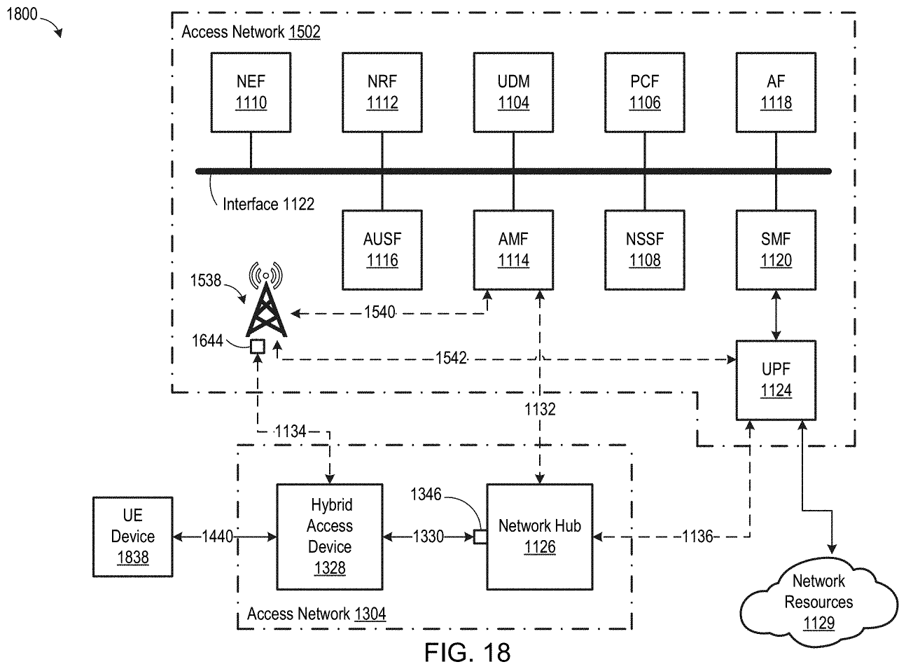

FIG. 18 is a block diagram of a communication system 1800, which is an alternate embodiment of communication system 1700 (FIG. 17), where UE device 1438 is replaced with a UE device 1838. UE device 1838 does not support the control plane of access network 1502. However, in some embodiments, network hub 1126 and/or access device 1328 are configured to bridge the control plane of access network 1502 and a control plane of access network 1304 by translating between the protocols of the two control planes, to enable the control plane of access network 1502 to at least partially control UE device 1838.

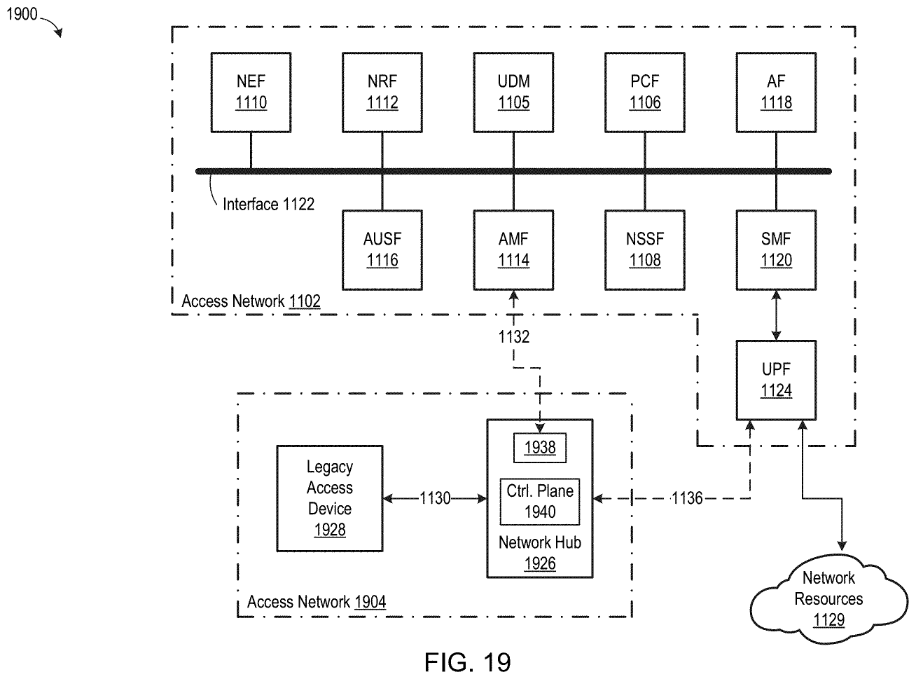

FIG. 19 is a block diagram of a communication system 1900, which is an alternate embodiment of communication system 1100 (FIG. 11) where access network 1104 is replaced by an access network 1904. Access network 1904 includes a network hub 1926 and a legacy access device 1928 communicatively coupled by communication link 1130. Network hub 1926 is an embodiment of network hub 1126 (FIG. 11). Legacy access device 1928 is similar to access device 1128 of FIG. 11, but legacy access device 1928 does not support the control plane of access network 1102, e.g. legacy access device 1928 is incompatible with access network 1102. Therefore, network hub 1926 includes an interworking function 1938 configured to bridge the control plane of access network 1102 and a control plane 1940 of access network 1904, by translating between protocols of the two control planes. Accordingly, the control plane of access network 1102 is capable of at least partially controlling legacy access device 1928 via interworking function 1938.

### Combinations of Features

Features described above may be combined in various ways without departing from the scope hereof. The following examples illustrate some possible combinations:

(A1) A method for supporting communication links may include (1) supporting a wireless communication link using a plurality of network functions logically linked via a common interface, (2) supporting a wireline communication link using a wireline access network, and (3) sharing one or more of the plurality of network functions with the wireline access network.

(A2) The method denoted as (A1) may further include bridging one or more interfaces of the wireline access network and the common interface.

(A3) Any one of the methods denoted as (A1) and (A2) may further include (1) authenticating a first user equipment (UE) device using the wireless communication link via a converged unified data management (C-UDM) of the plurality of network functions and (2) posting, in the C-UDM, authentication of an access device using the wireline communication link.

(A4) The method denoted as (A3) may further include using the wireline access network to authenticate the access device.

(A5) Any one of the methods denoted as (A3) and (A4) may further include associating first authentication information for the first UE device and second authentication information for the access device with a common identification element in the C-UDM.

(A6) In the method denoted as (A5), the first authentication information may include a mobile network subscription ID (IMSI) and an authentication protocol (AKA), and the second authentication information may include a security certificate.

(A7) In the method denoted as (A6), the security certificate may include one of a security certificate for a Wi-Fi device and a security certificate for a data over cable service interface specification (DOCSIS) protocol device.

(A8) Any one of the methods denoted as (A1) through (A7) may further include using a converged policy control function (C-PCF) of the plurality of network functions to apply a traffic policy to a data session traversing the wireline communication link.

(A9) The method denoted as (A8) may further include applying a common traffic policy to at least (1) a first data session traversing the wireless communication link and (2) a second data session traversing the wireline communication link, using the C-PCF.

(A10) The method denoted as (A9) may further include supporting a UE device with each of the first data session and the second data session.

(A11) Any one of the methods denoted as (A1) through (A10) may further include using a converged network slice function (C-NSSF) of the plurality of network functions to form a single network slice spanning the wireless communication link and the wireline communication link.

(A12) The method denoted as (A11) may further include providing a single quality of service (QoS) traffic management policy on the single network slice spanning the wireless communication link and the wireline communication link.

(A13) In any one of the methods denoted as (A11) and (A12), the single network slice spanning the wireless communication link and the wireline communication link may include one of a mobile broadband slice, a mobile transport slice, and an Internet of Things (IoT) slice.

(A14) Any one of the methods denoted as (A1) through (A13) may further include using a converged network exposure function (C-NEF) of the plurality of network functions to provide information on the wireless communication link and the wireline communication link, to a network analysis function.

(A15) The method denoted as (A14) may further include using the C-NEF to determine collective performance of the wireless communication link and the wireline communication link.

(A16) Any one of the methods denoted as (A1) through (A15) may further include using a converged network repository function (C-NRF) of the plurality of network functions to identify a network service at least partially supported by the wireline communication link.

(A17) The method denoted as (A16) may further include using the C-NRF to identify a network service spanning the wireless communication link and the wireline communication link.

(A18) In any one of the methods denoted as (A1) through (A17), the wireless communication link may operate according to a fifth generation (5G) new radio (NR) protocol, and the wireline communication link may operate according to a data over cable service interface specification (DOCSIS) protocol.

(A19) In any one of the methods denoted as (A1) through (A17), the wireless communication link may operate according to a fifth generation (5G) new radio (NR) protocol, and the wireline communication link may operate according to a digital subscriber line (DSL) protocol.

(A20) In any one of the methods denoted as (A1) through (A17), the wireless communication link may operate according to a fifth generation (5G) new radio (NR) protocol, and the wireline communication link may serve a Wi-Fi wireless base station.

(A21) Any one of the methods denoted as (A1) through (A20) may further include supporting (a) a wireless base station and (b) premises broadband access, using the wireline access network.

(B1) A converged core communication network may include (1) a memory subsystem and (2) a processing subsystem configured to execute instructions stored in the memory subsection to perform any one of the methods denoted as (A1) through (A21).

(B2) In the converged core communication network denoted as (B1), the memory subsystem may include a plurality of memory elements disposed at different respective locations, and the processing subsystem may include a plurality of processing elements disposed at different respective locations.

(C1) A method for using a common control plane to control a plurality of access networks may include (1) supporting a first communication link of a first access network using a control plane of the first access network and (2) supporting a second communication link of a second access network using the control plane of the first access network.

(C2) In the method denoted as (C1), the first access network may include a wireless access network, and the second access network may include a wireline access network.

(C3) In the method denoted as (C2), the wireless access network may include one or more of a fourth generation (4G) wireless access network, a fifth generation (5G) wireless access network, a sixth generation wireless (6G) access network, and an Institute of Electrical and Electronics Engineers (IEEE) 802-11 wireless access network, and the wireline access network may include one or more of a cable access network, an optical access network, and a digital subscriber line (DSL) access network.

(C4) Any one of the methods denoted as (C1) through (C3) may further include supporting the second communication link via at least one control plane logical link between the first and second access networks.

(C5) Any one of the methods denoted as (C1) through (C4) may further include at least partially controlling an access device via a control plane logical link between the access device and the first access network, the access device being communicatively coupled to the second access network via the second communication link.

(C6) The method denoted as (C5) may further include transmitting data between the access device and network resources by simultaneously using respective communication interfaces of each of the first and second access networks.

(C7) Any one of the methods denoted as (C5) and (C6) may further include at least partially controlling a user equipment (UE) device communicatively coupled to the access device, via a control plane logical link between the UE device and the first access network.

(C8) The method denoted as (C7) may further include transmitting data between the UE device and network resources by simultaneously using respective communication interfaces of each of the first and second access networks.

(C9) The method denoted as (C7) may further include selecting between respective communication interfaces of each of the first and second access networks for transmitting data between the UE device and network resources.

(C10) Any one of the methods denoted as (C1) through (C9) may further include bridging the control plane of the first access network and a control plane of the second access network, to control a device communicatively coupled to the second access network that does not support the first control plane.

(C11) Any one of the methods denoted as (C1) through (C10) may further include selecting a service flow of the second access network according to a quality of service (QoS) traffic management policy of the first access network.

(C12) Any one of the methods denoted as (C1) through (C10) may further include creating a service flow in the second access network to implement a quality of service (QoS) traffic management policy of the first access network.

(D1) A communication system may include (a) a first access network and (b) a second access network, wherein the first and second access networks are collectively configured such that a control plane of the first access network at least partially controls the second access network.

(D2) In the system denoted as (D1), the first access network may include a wireless access network, and the second access network may include a wireline access network.

(D3) In the system denoted as (D2), the wireless access network may include one or more of a fourth generation (4G) wireless access network, a fifth generation (5G) wireless access network, a sixth generation wireless (6G) access network, and an Institute of Electrical and Electronics Engineers (IEEE) 802-11 wireless access network, and the wireline access network may include one of a cable access network, an optical access network, and a digital subscriber line (DSL) access network.

(D4) In the system denoted as (D3), the first and second access networks may be further collectively configured to establish at least one control plane logical link between the first and second access networks.

(D5) In any one of the systems denoted as (D1) through (D4), the first and second access networks may be further collectively configured to transmit data between a device communicatively coupled to the second access network and network resources, by simultaneously using respective communication interfaces of each of the first and second access networks.

(D6) In any one of the systems denoted as (D1) through (D5), at least one of the first and second access networks may be configured to bridge the control plane of the first access network and a control plane of the second access network, to control a device communicatively coupled to the second access network that does not support the first control plane.

(D7) In any one of the networks denoted as (D1) through (D6), the second access network may be configured to select a service flow of the second access network according to a quality of service (QoS) traffic management policy of the first access network.

(D8) In any one of the networks denoted as (D1) through (D6), the second access network may be configured to create a service flow in the second access network to implement a quality of service (QoS) traffic management policy of the first access network.

Changes may be made in the above methods, devices, and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which, as a matter of language, might be said to fall therebetween.

What is claimed is:

1. A method for using a common control plane to control a plurality of access networks, comprising:
supporting a first communication link of a first access network using a control plane of the first access network; and
supporting a second communication link of a second access network using the control plane of the first access network.

2. The method of claim 1, wherein:
the first access network comprises a wireless access network; and
the second access network comprises a wireline access network.

3. The method of claim 2, wherein:
the wireless access network comprises one or more of a fourth generation (4G) wireless access network, a fifth generation (5G) wireless access network, a sixth generation wireless (6G) access network, and an Institute of Electrical and Electronics Engineers (IEEE) 802-11 wireless access network; and
the wireline access network comprises one or more of a cable access network, an optical access network, and a digital subscriber line (DSL) access network.

4. The method of claim 1, further comprising supporting the second communication link via at least one control plane logical link between the first and second access networks.

5. The method of claim 1, further comprising at least partially controlling an access device via a control plane logical link between the access device and the first access network, the access device being communicatively coupled to the second access network via the second communication link.

6. The method of claim 5, further comprising transmitting data between the access device and network resources by simultaneously using respective communication interfaces of each of the first and second access networks.

7. The method of claim 5, further comprising at least partially controlling a user equipment (UE) device communicatively coupled to the access device, via a control plane logical link between the UE device and the first access network.

8. The method of claim 7, further comprising transmitting data between the UE device and network resources by simultaneously using respective communication interfaces of each of the first and second access networks.

9. The method of claim 7, further comprising selecting between respective communication interfaces of each of the first and second access networks for transmitting data between the UE device and network resources.

10. The method of claim 1, further comprising bridging the control plane of the first access network and a control plane of the second access network, to control a device communicatively coupled to the second access network that does not support the first control plane.

11. The method of claim 1, further comprising selecting a service flow of the second access network according to a quality of service (QoS) traffic management policy of the first access network.

12. The method of claim 1, further comprising creating a service flow in the second access network to implement a quality of service (QoS) traffic management policy of the first access network.

13. A communication system, comprising:
a first access network; and
a second access network;
wherein the first and second access networks are collectively configured such that a control plane of the first access network at least partially controls the second access network.

14. The system of claim 13, wherein:
the first access network comprises a wireless access network; and
the second access network comprises a wireline access network.

15. The system of claim 14, wherein:
the wireless access network comprises one or more of a fourth generation (4G) wireless access network, a fifth generation (5G) wireless access network, a sixth generation wireless (6G) access network, and an Institute of Electrical and Electronics Engineers (IEEE) 802-11 wireless access network; and
the wireline access network comprises one of a cable access network, an optical access network, and a digital subscriber line (DSL) access network.

16. The system of claim 13, wherein the first and second access networks are further collectively configured to establish at least one control plane logical link between the first and second access networks.

17. The system of claim 13, wherein the first and second access networks are further collectively configured to transmit data between a device communicatively coupled to the second access network and network resources, by simultaneously using respective communication interfaces of each of the first and second access networks.

18. The system of claim 13, wherein at least one of the first and second access networks is configured to bridge the control plane of the first access network and a control plane of the second access network, to control a device communicatively coupled to the second access network that does not support the first control plane.

19. The system of claim 13, wherein the second access network is configured to select a service flow of the second access network according to a quality of service (QoS) traffic management policy of the first access network.

20. The system of claim 13, wherein the second access network is configured to create a service flow in the second access network to implement a quality of service (QoS) traffic management policy of the first access network.
